(19) United States
(12) Patent Application Publication
(10) Pub. No.: US 2010/0211637 A1
(43) Pub. Date: Aug. 19, 2010

(54) METHOD AND APPARATUS FOR PROVIDING SHARED SERVICES

(75) Inventors: Mihaly Laszlo Borzsei, Tampere (FI); Seamus Moloney, Riihimaki (FI)

Correspondence Address: DITTHAVONG MORI & STEINER, P.C., 918 Prince Street, Alexandria, VA, 22314, US

(73) Assignee: Nokia Corporation, Helsinki (FI)

(21) Appl. No.: 12/413,175

(22) Filed: Mar. 27, 2009

Related U.S. Application Data
(63) Continuation-in-part of application No. 12/372,260, filed on Feb. 17, 2009.

(51) Int. Cl. G06F 15/16; G06F 17/30; G06Q 99/00

(52) U.S. Cl. 709/204; 709/228; 726/5; 705/319

(57) ABSTRACT

An approach is provided for shared mobile services. A node joins a community of a plurality of mobile servers for sharing a service. The node provides the service to a service consumer.

### RELATED APPLICATIONS

The present application is a Continuation-In-Part of the U.S. patent application Ser. No. 12/372,620 filed Feb. 17, 2009, entitled “Method and Apparatus for Providing Shared Services”; the contents of which are hereby incorporated by reference.

### BACKGROUND

Wireless (e.g., cellular) service providers and device manufacturers are continually challenged to deliver value and convenience to consumers by, for example, providing compelling network services, applications, and content. In light of an increasingly web-centric culture, one emerging service is the use of wireless devices to provide mobile web services. These services, for example, include hosting web applications and content on a mobile handset for sharing with other users. However, limited resources (e.g., bandwidth, processing power, availability of the mobile web server) within the wireless environment pose significant problems to implementing web services on mobile devices.

### SOME EXEMPLARY EMBODIMENTS

Therefore, there is a need for an approach for providing shared mobile web services.

According to one embodiment, an apparatus comprising a processor and a memory storing executable instructions that if executed cause the apparatus to join a community of a plurality of mobile servers for sharing a service. The apparatus is also caused to provide the service to a service consumer.

According to another embodiment, a computer-readable storage medium carrying one or more sequences of one or more instructions which, when executed by one or more processors, cause an apparatus to join a community of a plurality of mobile servers for sharing a service. The apparatus is also caused to provide the service to a service consumer.

According to another embodiment, a method comprises joining a community of a plurality of mobile servers for sharing a service. The method also comprises providing the service to a service consumer.

According to yet another embodiment, an apparatus comprises means for joining a community of a plurality of mobile servers for sharing a service. The apparatus also comprises means for providing the service to a service consumer.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a communication system capable of providing shared services, according to an exemplary embodiment;

FIG. 2 is a diagram of components of a shared services module, according to an exemplary embodiment;

FIG. 3 is a flowchart of a process for providing shared services, according to an exemplary embodiment;

FIG. 4 is a flowchart of a process for providing a shared mobile web service, according to an exemplary embodiment;

FIG. 5 is a flowchart of a process for registering a mobile web service, according to an exemplary embodiment;

FIGS. 6A and 6B are flowcharts of a process for creating a community for sharing a mobile web service, according to an exemplary embodiment;

FIG. 7 is a flowchart of a process for authenticating users and providers of a shared mobile web service, according to an exemplary embodiment;

FIGS. 8A and 8C are diagrams of a user interface utilized in the process of FIG. 5, according to an exemplary embodiment;

FIG. 9 is a ladder diagram that illustrates a sequence of messages and processes for providing a shared web service, according to an exemplary embodiment;

FIG. 10 is a ladder diagram that illustrates a sequence of messages and processes for providing a shared web service anonymously, according to an exemplary embodiment;

FIG. 11 is a diagram depicting a service provider providing a shared service anonymously, according to an exemplary embodiment;

FIG. 12 is a ladder diagram that illustrates a sequence of messages and processes for providing a shared web service as a passive server, according to an exemplary embodiment;

FIG. 13 is a ladder diagram that illustrates a sequence of messages and processes for providing a shared web service using authentication keys, according to an exemplary embodiment;

FIG. 14 is a ladder diagram that illustrates a sequence of messages and processes for load-balancing a shared web service, according to an exemplary embodiment;

FIG. 15 is a diagram of hardware that can be used to implement an embodiment of the invention;

FIG. 16 is a diagram of a chip set that can be used to implement an embodiment of the invention; and

FIG. 17 is a diagram of a mobile station (e.g., handset) that can be used to implement an embodiment of the invention.

### DESCRIPTION OF PREFERRED EMBODIMENT

A method and apparatus for providing shared services are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various exemplary embodiments are described with respect to sharing web services within a wireless network environment, it is contemplated that the approach for sharing services described herein may be used within any type of communication system or network, and other services or applications.

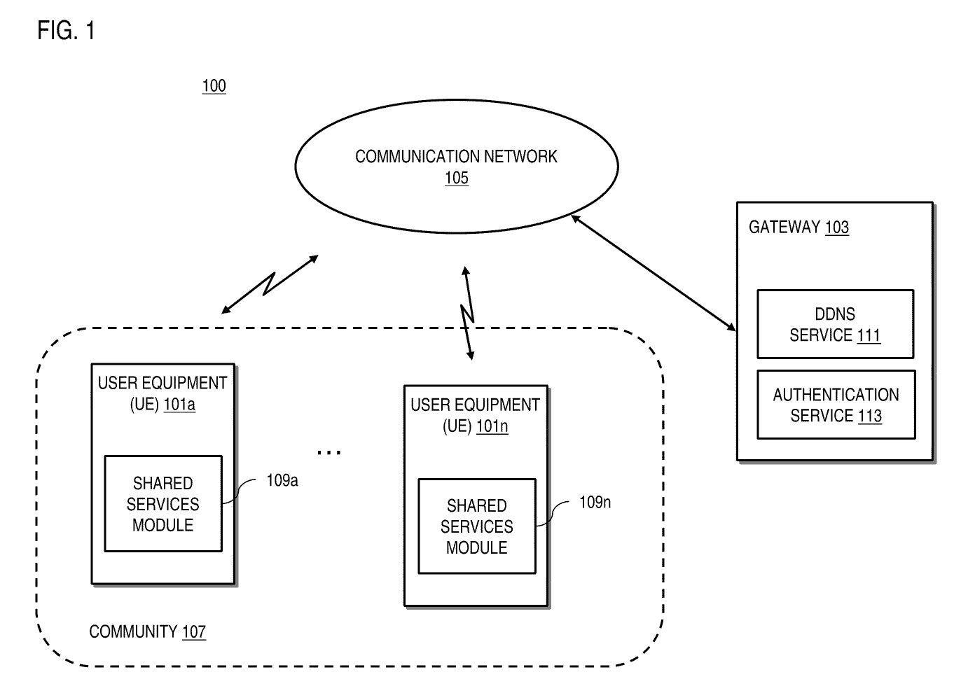

FIG. 1 is a diagram of a communication system capable of providing shared services, according to an exemplary embodiment. As shown in FIG. 1, a system 100 comprises one or more user equipment (UEs) (e.g., UEs 101a-101n) having connectivity to a gateway 103 via a communication network 105. The UEs 101a-101n are any type of fixed terminal, mobile terminal, or portable terminal including desktop computers, laptop computers, handsets, stations, units, devices, multimedia tablets, Internet nodes, communicators, Personal Digital Assistants (PDAs), or any combination thereof. It is also contemplated that the UEs 101a-101n can support any type of interface to the user (such as “wearable” circuitry, etc.). The UEs 101a-101n act as mobile web servers to permit mobile hosting of web services for sharing within a community 107 of the UEs 101a-101n.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), and the like.

As discussed previously, implementing mobile web services within a wireless environment taxes the limited resources (e.g., bandwidth, processing power, availability of the mobile server, etc.) that are available within the environment. For instance, running a photo-sharing web service on a mobile handset can potentially overwhelm the capabilities of the handset when multiple users are connected, or when large pictures files are being transferred. The system 100 addresses this problem by designating a community 107 of mobile web servers (e.g., UEs 101a-101n) that redundantly provide one or more web services. More specifically, a gateway 103 designates multiple UEs 101a-101n as a community 107 for sharing a web service. The gateway 103 designates one UE 101 to act as a primary server for the web service and may designate one or more other UEs 101 as secondary servers. When a service request is received, the gateway 105 detects whether the designated primary server is available. It is contemplated that availability depends on factors such as whether the UE 101 acting as the primary server is online (e.g., powered on and connected to the data network) and the number of other requests the primary server is handling. If the primary server is not available, the gateway dynamically selects a secondary server to service the request.

As shown in FIG. 1, the UEs 101a-101n each include, for instance, a shared services module 109 to coordinate the sharing of a web service with the gateway 105. In exemplary embodiments, the shared services module 109 contains a listing of web services available on the UE 101. For example, the web service listing includes a service descriptor and associated files (e.g., data or content files) for providing the service. The service descriptor, for instance, includes a list of service items (e.g., files, logs, scripts, etc. associated with the service). It is contemplated that the service items may include the files installed as part of the service, as well other files available to the UE 101 (e.g., personal information management (PIM) files resident on the device). The service descriptor also includes a list of dependencies (i.e., additional services or modules that are installed with the service). For example, dependencies may include a SQL database service or an Apache module. In addition, the service descriptor includes configuration settings for setting up the web service when it is first installed on the UE 101. The service configuration settings, for instance, may contain information to register the service with the gateway 103 or information on any actions needed from the user or the UE 101 to complete installation of the service (e.g., confirm privacy settings, etc.).

To assist the UEs 101a-101n in providing shared services, the gateway 103, for example, includes a dynamic domain name server (DDNS) service 111 and an authentication service 113. The DDNS service 111 enables the gateway 103 to maintain a list of domains, subdomains, and mobile servers associated with a web service. In exemplary embodiments, the DDNS service 111 designates a primary server and secondary servers for a web service. For example, as each mobile server (e.g., a UE 101) enters or leaves the communication network 105, the mobile server registers or deregisters with the DDNS service 111. In the event the mobile server is unable to deregister before leaving the network (e.g., when the server suddenly loses power), the DDNS service 111 provides for a timeout period. For instance, if the mobile server does not respond during the timeout period, the DDNS service 111 assumes the mobile server is unavailable.

The authentication service 113 enables the gateway to authenticate the mobile servers within the community 107 as well as the users of the web services provided by the mobile servers. It is contemplated that any type of authentication scheme (e.g., a user name and password, a key access number, a unique machine identifier (e.g., MAC address), and the like, as well as combinations thereof) may be used to ensure that only authorized mobile servers and users have access to the web services of system 100.

By way of example, the UEs 101a-101n communicate with other devices (i.e., network nodes) on the communication network 105 (e.g., the gateway 103, users of the web services) using standard protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model. The OSI Reference Model is generally described in more detail in Section 1.1 of the reference book entitled “Interconnections Second Edition,” by Radia Perlman, published September 1999.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

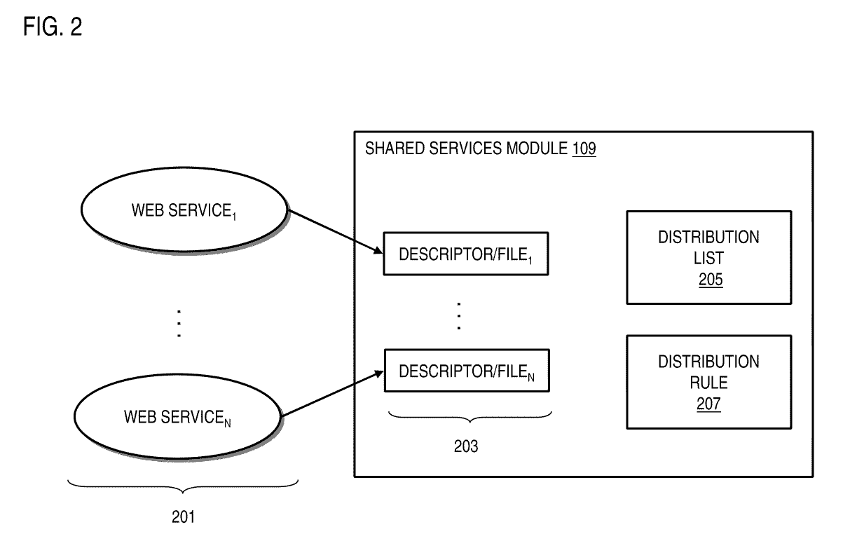

FIG. 2 is a diagram of components of a shared services module, according to an exemplary embodiment. By way of example, the shared services module 109 includes one or more components for providing a shared web service. In this embodiment, the shared services module 109 includes a list of web services 201 offered by a mobile server (e.g., a UE 101). As discussed with respect to FIG. 1, a web service listing includes a service descriptor and associated files 203.

Each web service 201 is also associated with a distribution list 205 and a distribution rule 207. The distribution list 205 identifies all of the mobile servers (e.g., UEs 101a-101n) that are sharing a particular service. In exemplary embodiments, a mobile server may dynamically enable or disable a particular service at will. To keep track of the status of a particular mobile server, the distribution list 205 contains a list of mobile servers along information on whether each server has enabled or disabled the service. For example, family members participate in a photo-sharing web service with each other. This service enables each member to share pictures taken from the mobile device's camera. However, while on vacation, certain members of the family have been designated as the official photographers for the photo-sharing web service. Accordingly, the members who are not the designated photographers temporarily disable their photo-sharing web service. The distribution list 205 is used to track which family members are actively sharing the service.

In exemplary embodiments, the distribution rule 207 specifies how the gateway 103 should act when a particular web service is shared. The distribution rule 207, for instance, tells the gateway 103 whether to create a new domain or a new subdomain when a particular web service is shared. For example, a community 107 of mobile servers has already created a domain name (e.g., “community1.com”) and has initiated sharing a calendar web service. The distribution rule 207 associated with the calendar service directs the gateway 103 to create a new subdomain (e.g., “calendar.community1.com”) because a domain already exists. If there were no existing domain name, the gateway 103 may be directed to create both a new domain and subdomain or a new domain only.

In certain embodiments, the distribution rule 207 may also be used to direct service requests to one or more particular mobile servers. For instance, the rule 207 may specify that service requests should go to a secondary server before the primary server, even though, by default, the gateway 103 directs service requests to the primary server before the secondary servers. It is also contemplated that a distribution rule 207 may be used to manually direct incoming service requests to another server using a distribution rule 207. For example, a first user would like to temporarily to suspend a web service. To do this, the first user may create a new distribution rule 207 for the web service to direct the service requests to another mobile server temporarily.

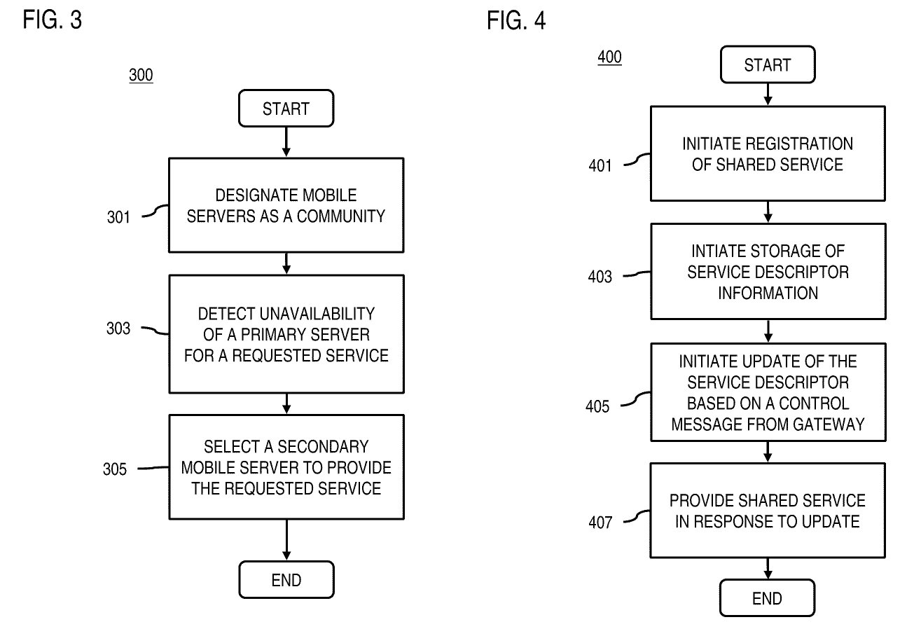

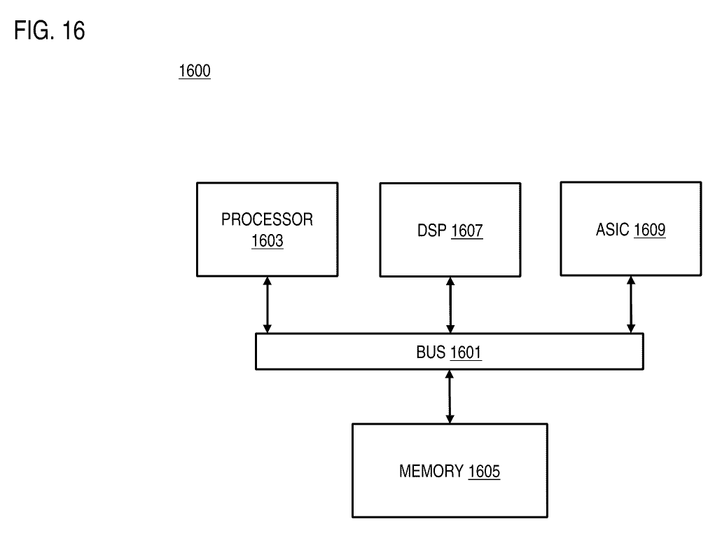

FIG. 3 is a flowchart of a process for providing shared services, according to an exemplary embodiment. In one embodiment, the gateway 103 performs process 300 and is implemented in, for instance, a chip set including a processor and a memory as shown FIG. 16. In step 301, the process 300 designates multiple mobile servers (e.g., UEs 101a-101n) as a community for sharing a web service. During the step of designating a community, the gateway 103 also designates, for instance, a primary mobile server for the web service and one or more secondary servers. In exemplary embodiments, the mobile server (e.g., UE 101a) making an initial request for sharing the web service is designated the primary server. It is contemplated that users may manually designate the primary and secondary servers as well. This manual designation may be made at the initial setup of the web service or at any later time.

In exemplary embodiments, the primary server, by default, is the first to receive a request directed to the web service. Accordingly, on receipt of a service request, the gateway 103 detects whether the primary server is available to provide the shared service (step 303). The primary server available depends, for example, on a variety of factors including the primary server's current load (e.g., processor load, network traffic load), any distribution rules (e.g., a rule directing the service request to another mobile server), and whether the primary server is connected to the network 105. For example, by assessing the load (e.g., processor, network traffic, etc.) on the primary server (or alternatively any of the primary or secondary servers), the gateway 103 may designate a primary server as unavailable and distribute the service request to secondary services to perform load-balancing and make more efficient use of network resources. If the primary server is available, the gateway 103 directs the service request to the primary server. If the primary server is unavailable (e.g., based on load or other factors), the gateway 103 directs the service request to a secondary server (step 305).

Certain embodiments include the process 300 within a network-enabled computing platform (e.g., hardware such as a computer, server, etc.). The incorporation of the process 300 within the computing platform extends these functions to the communication network 105 or communication system 100 in which the computing platform operates.

FIG. 4 is a flowchart of a process for providing a shared mobile web service, according to an exemplary embodiment. In one embodiment, the shared services module 109 performs the process 400 and is implemented in, for instance, a chip set including a processor and a memory as shown FIG. 16. The example of FIG. 4 assumes that the web service has already been installed on a mobile server (e.g., UE 101). In step 401, the shared services module 109 initiates registration of the shared web service with the gateway 103. In exemplary embodiments, the initiation of the registration is triggered automatically on installation of the shared web service on the mobile server. In other embodiments, the registration step may be configured to occur manually. The shared services module 109 then stores the service descriptor associated with the shared service (step 403). As described with respect to FIG. 1, the service descriptor, for instance, includes a list of service items (e.g., files, logs, scripts, etc. associated with the service), a list of dependencies (i.e., additional services or modules that are installed with the service), and configuration settings.

Periodically, the shared services module 109 receives, for example, a message from the gateway 103 to update or synchronize the service descriptor associated with a web service and initiates an update or synchronization as directed (step 405). Additionally, the shared services module 109 similarly provides its local copy of the service descriptor to the gateway 103 and other mobile servers running the shared web service (step 407). In exemplary embodiments, the shared web service is distributed among multiple mobile servers. Each multiple server may potentially update and/or provide the shared services per a user request. Over time, the data associated with the web service contained in the service descriptor may differ. Periodic updates and synchronization of the service descriptor among the mobile servers sharing the web service ensures that each mobile server has the latest data to provide the most up-to-date service.

As discussed previously, certain embodiments include the shared services module 109 within the UEs 101a-101n (e.g., hardware such as a wireless handset, etc.). The incorporation of the process 400 within the UEs 101a-101n extends the functions of the module 109 to the communication network 105 or communication system 100 in which the UE 101 operates.

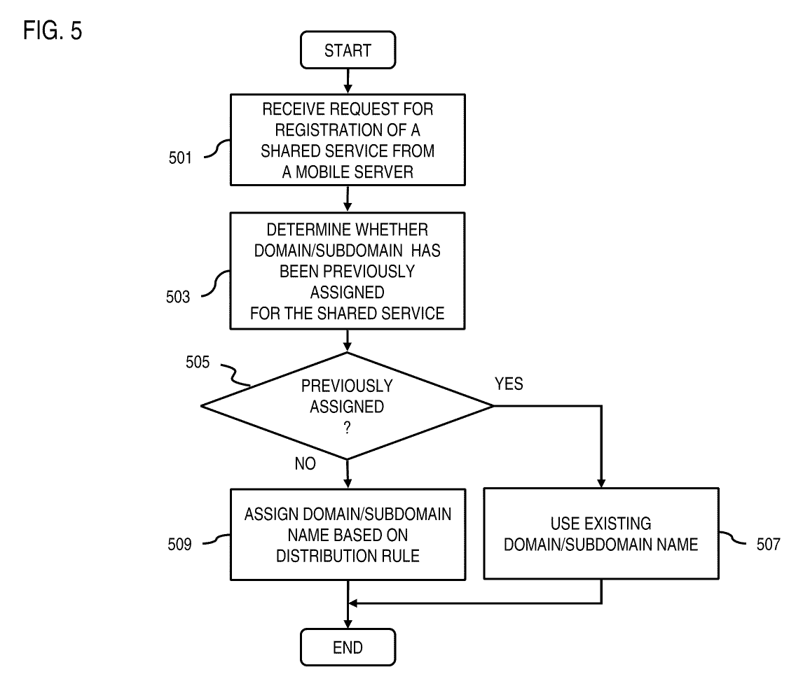

FIG. 5 is a flowchart of a process for registering a mobile web service, according to an exemplary embodiment. In step 501, the gateway 103 receives a request for registration of a shared web service from a mobile server (e.g., UE 101). The request includes, for example, a service descriptor, distribution list 205, and distribution rule 207 for the shared service. As discussed previously, the distribution rule 207 provides direction for how the DDNS service 111 should register the service (e.g., whether to create a new domain or subdomain). On receipt of the request, the gateway 103 determines whether a domain or subdomain has previously been assigned to the shared service (steps 503 and 505). If there is an existing domain or subdomain, the gateway 103 uses the existing name (step 507). If there is not, the gateway 103 assigns a new domain or subdomain name based on the associated distribution rule 207 (step 509).

For example, a family creates a new community 107 for sharing a web service. The family has not previously created any web service and is now requesting a movie booking web service for the family. In response, the gateway 103 determines whether there is a domain assigned to web services associated with this particular community 107. In this case, there is no previously assigned domain or subdomain, and the DDNS service 111 assigns a new domain name (e.g., “family.com”). The DDNS service 111 then assigns a subdomain associated with the movie booking service (e.g., “movies.family.com”).

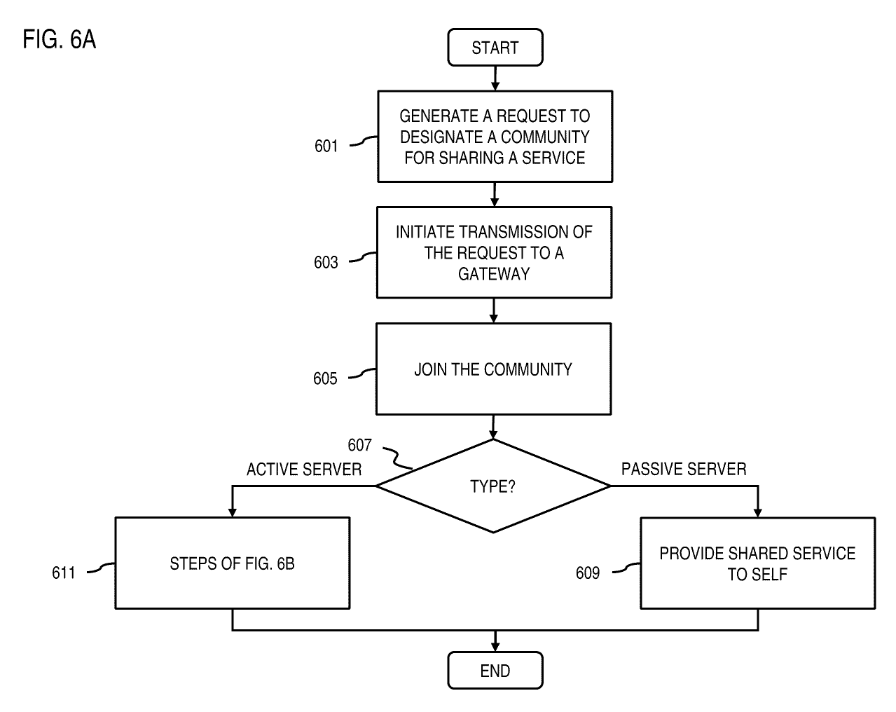

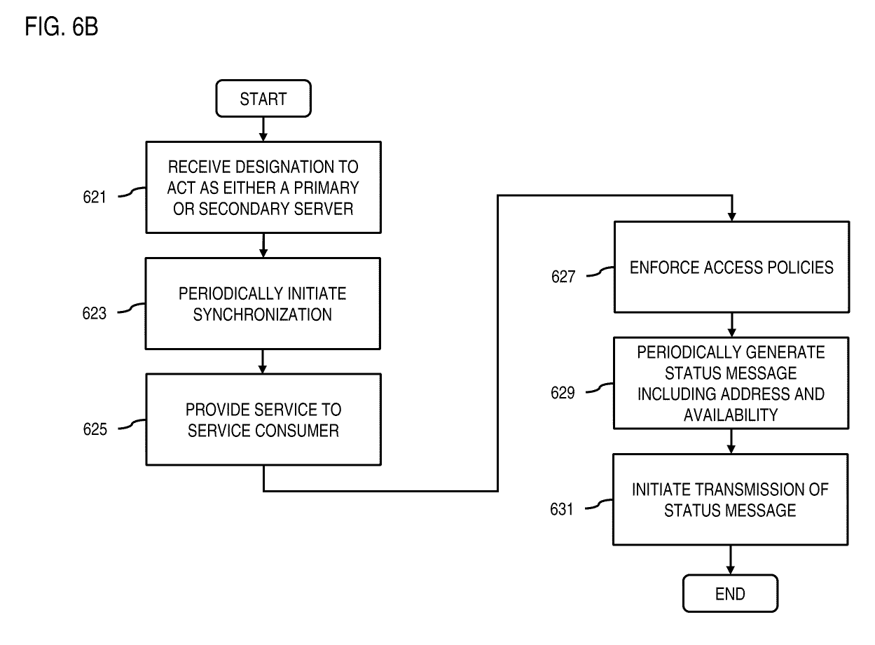

FIGS. 6A and 6B are flowcharts of a process for creating a community for sharing a mobile web service, according to an exemplary embodiment. In one embodiment, the shared services module 109 performs the process 600 of FIG. 6A and is implemented in, for instance, a chip set including a processor and a memory as shown in FIG. 16. The example of FIGS. 6A and 6B assumes that the shared mobile web service has already been installed on a mobile server (e.g., UE 101). For example, the mobile server may download and install an application supporting the shared service from an application server. The mobile may also obtain the application from the gateway 103 or other server within the communication network 105. In step 601, the shared services module 109 generates a request to designate a community 107 of a plurality of mobile servers (e.g., UEs 101a-101n) for sharing a mobile web service. In exemplary embodiments, the mobile servers within the designated community provide the shared mobile web service to one or more service consumers. As used herein, the term “service consumer” refers to any device capable of communicating over the communication network 105 that requests the shared mobile web service. The shared mobile services module 109 then initiates transmission of the request to the gateway 103 (step 603). On receipt of the request, the gateway 103 designates the community 107 using, for instance, the process described with respect to FIG. 3.

By way of example, the shared services module 109 may designate the community 107 based on an existing social networking community or a subset of a social networking community. The social networking community may be external to the communication network 105 (e.g., social networking communities hosted by Facebook®, MySpace®, etc.) or may be internal to the communication network 105. If the social networking community is external to the communication network 105, the gateway 103 may interact with the external community using, for instance, an application programming interface (API) provided by the external community to designate specific members of the community 107. It is contemplated that either the gateway 103 and/or the external social networking community may manage (e.g., control membership, distribute information or files related to the shared mobile web service) the community 107. For example, a user of a mobile phone incorporating the mobile server for shared services may associate and control membership settings using the contact information stored in the memory of the mobile phone (e.g. using any UI provided for the access and control of contact information, such as contacts address book application, phonebook application, calendar application, messaging applications, and/or the like).

In the request of step 601, the shared services module 109 may specify either a social networking community or a subset of the networking community to provide the shared service. For example, the shared services module 109 may use a standard protocol (e.g., OpenID) for identifying particular members of the social networking community. When using such a protocol, the request of step 601 need only specify the identification marker (e.g., OpenID) associated with each member of the community to inform the gateway 103 about the members of the social networking community who can run or use the shared mobile web service. Verification and authentication of the mobile server associated with the identification marker (e.g., OpenID) is then performed according to the corresponding protocol.

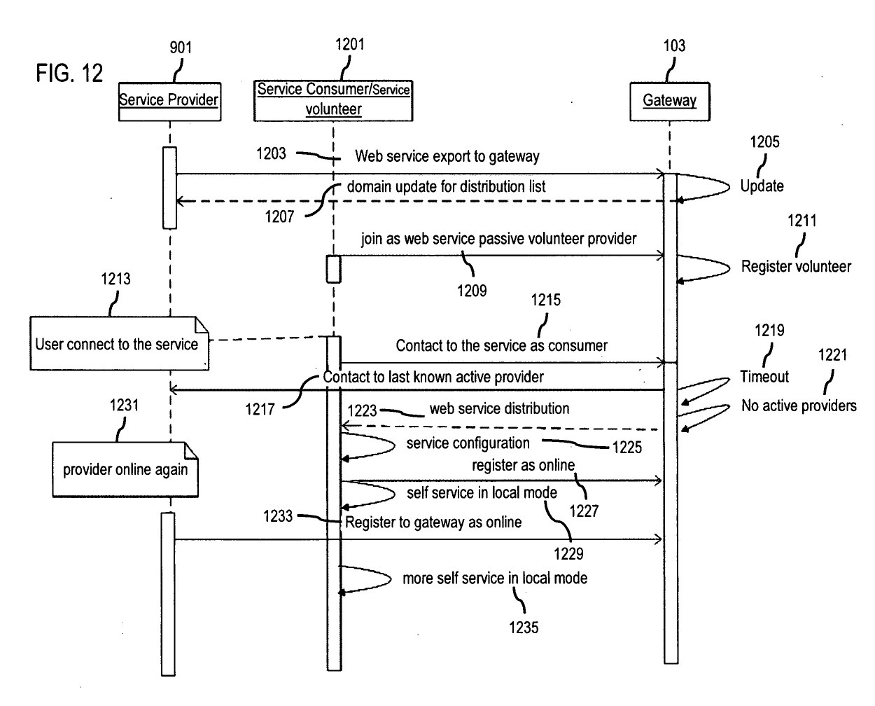

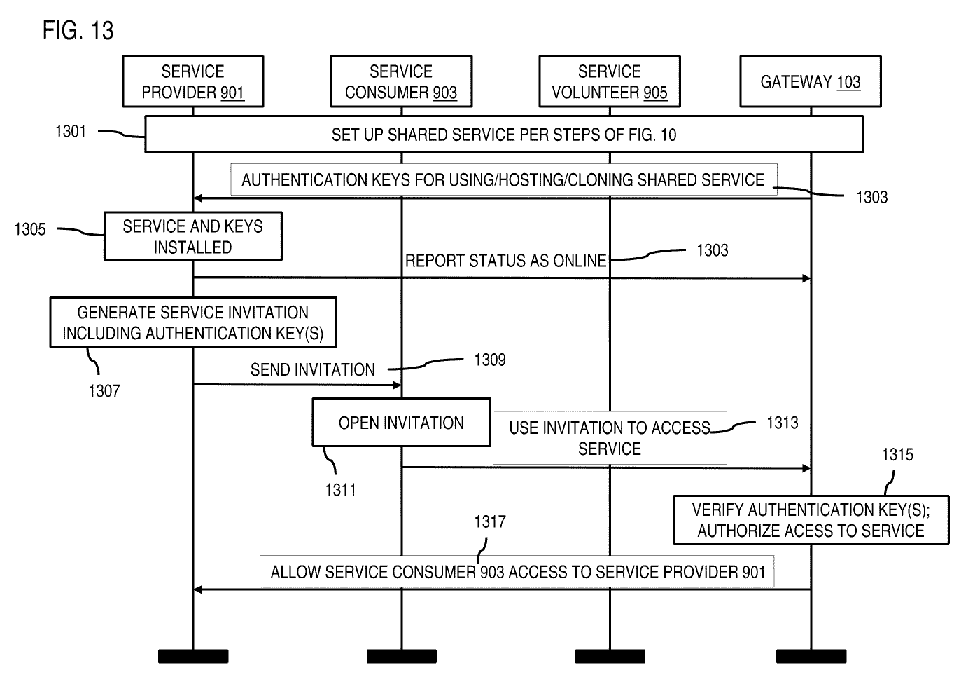

The shared services module 109 can then direct a mobile server to join the designated community 107 (step 605) as either an active server or a passive server (step 607). In exemplary embodiments, an active server provides the shared mobile web service associated with the community 107 to any service consumer requesting the shared service, whereas a passive server joins the community 107 to provide the shared service to itself, for instance, when other active servers (e.g., the primary server or the one or more secondary servers) are not available (step 609). It is contemplated that a mobile may alternate between acting as an active server and a passive server according to user specification or other availability criteria (e.g., available quality of service, data quota, bandwidth, etc.). The process of self-serving the shared service is described in more detail with respect to FIG. 12. The process of acting as an active server is described with respect to FIG. 6B.

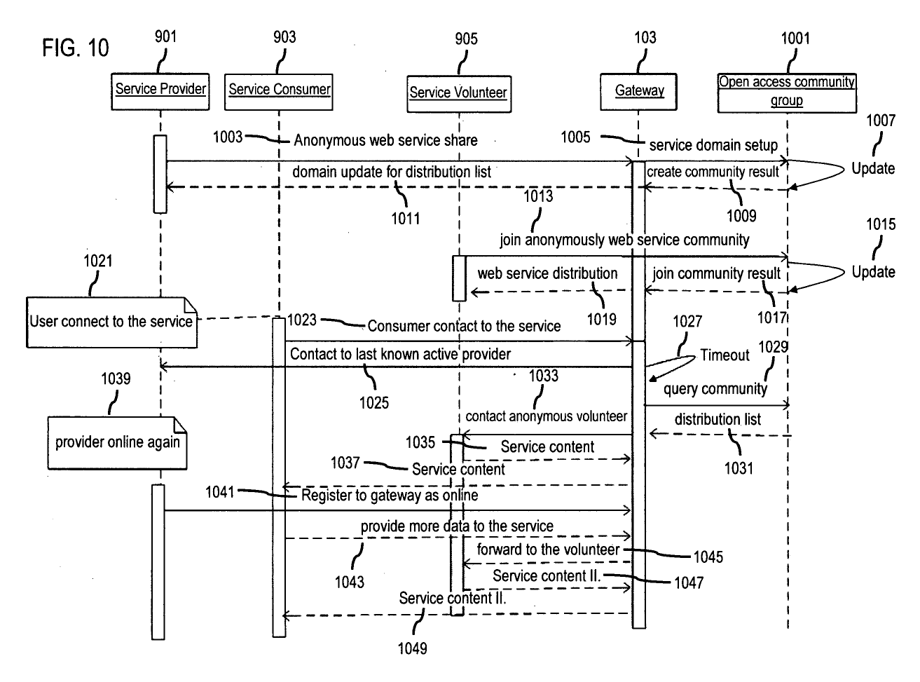

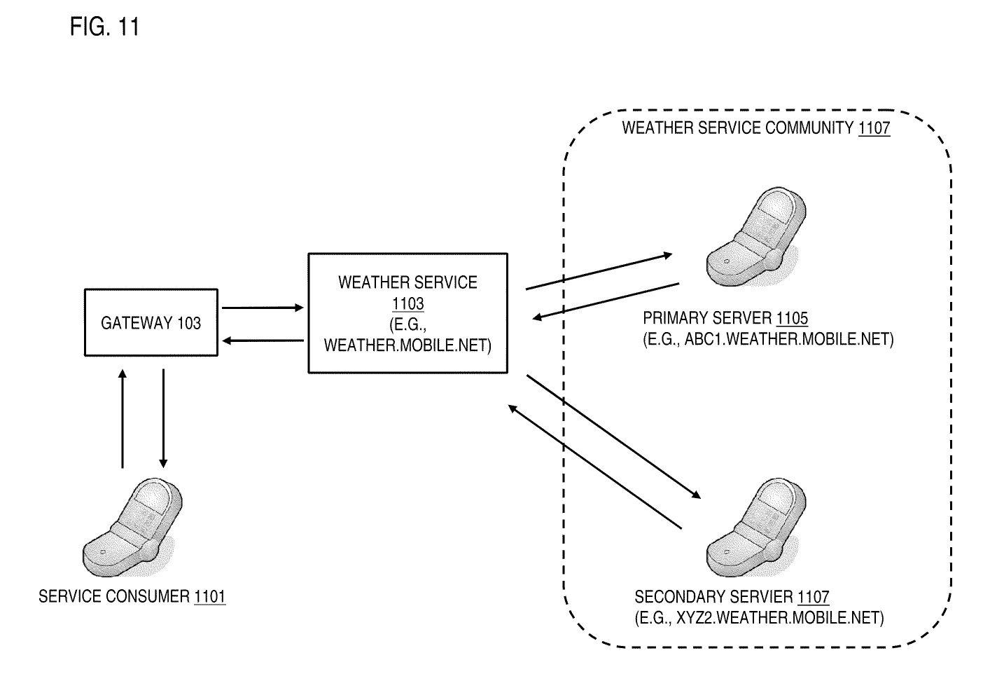

In addition, a mobile server may join the community 107 to provide the shared mobile service anonymously. For example, when providing a service anonymously, the identity of the specific mobile server that provides the shared service is not known to the service consumer. Instead, the service consumer directs its service request to a non-identifying domain name (e.g., service.mobile.net) associated with the community 107. The mobile serve may also join the community with complete anonymity to both other mobile servers with the community 107 as well service consumers. It is contemplated that the user may specify the appropriate level of anonymity for a specific mobile server. Anonymity settings may also be configured on a community-wide level. The gateway 103 is then responsible for selecting an appropriate mobile server from the community 107 to provide the service in accordance with the request and the requested level of anonymity (e.g., anonymity in which a particular mobile server is not identified to the corresponding service consumer. The process of providing a shared mobile web service anonymously is described in more details with respect to FIGS. 10 and 11.

FIG. 6B is a flowchart of a process for providing a shared service as an active server, according to an exemplary embodiment. In step 601, after joining a community 107, the shared services module 109 receives a designation to act as either a primary server or a secondary server. In exemplary embodiments, both the primary and secondary servers are active servers within the community (i.e., serve requests from other service consumers). For example, the gateway 103 directs a service request from the one or more service consumers to the primary server when the primary server is available and to the secondary server when the primary server is not available. It is contemplated that the designation or the availability of the primary server and the secondary server may be specified by a user of a UE 101 comprising the server, determined by a user-defined context, or determined by application of predetermined service criteria. By way of example, the user may specify user-defined contexts or service criteria during service registration. The contexts define when and under what conditions a mobile server is available for service, and may include contexts such as location (e.g., a server may be active only at certain locations or a server may be a primary server at one location and a secondary server at another location), time (e.g., a server may be active only at specific times), and/or the like. It is contemplated that the user may define any appropriate context for availability. Like user-defined contexts, the predetermined service criteria may, for instance, include location and time. The service criteria may also include the type of network connection (e.g., a server connected via a local area network may offer higher levels of service than a server connected via cellular connection), quality of service, device capability (e.g., available memory and battery life may limit a mobile server's ability to provide the shared service), nature of the shared service (e.g., whether the shared mobile services require specific components or sources of information that may not be available on all mobile servers within the community), or a combination thereof.

In exemplary embodiments, a user associated with a mobile server may indicate during what times of the day the mobile server is active and what times the server is inactive. The schedule of when a mobile server is active may be indicated, for instance, using a calendar application. Additionally, the service criteria described above enables the mobile web server to specify one or more contexts (e.g., location, time) for when the mobile server can provide a certain quality of service to service consumers. It is contemplated that the quality of service includes both quality of physical network connections (e.g., bandwidth, connection type, number of concurrent connections) as well as quality of the information for providing the shared service. For example, during configuration of the shared web service on a mobile server, specific geographical areas may be indicated on a map in which the mobile server can provide good service. For instance, when sharing a shopping list service, the mobile server can indicate that it is able to update prices for shopping items when the mobile server is located within a store. The gateway 103 may use information on the quality of service offered by a mobile server to route service requests from service consumers.

As shown in FIG. 6B, after receiving the designation to act as either a primary or secondary server, the shared services module 109 periodically initiates synchronization of the shared web service (e.g., synchronization of the service descriptor and associated files 203) among the other mobile servers within the community 107 (step 623). In exemplary embodiments, the initiation of synchronization may be triggered according to a schedule, according to service updates (e.g., when new information is added), at the request of one or more mobile servers, at the request of the gateway 103, or other appropriate trigger. The shared services module 109 can respond to requests from service consumers and provide the shared mobile web service (step 625).

In addition to providing the shared service, the shared services module 109 may also enforce access policies associated with the shared mobile web service or the communication network 105 (step 627). These access policies include, for instance, a bandwidth threshold, data quota, limit on the number of connections, threshold on transfer ratio (e.g., the ratio of incoming and outgoing data transfers from a mobile server), or a combination thereof. It is contemplated that the access policies may be defined by the shared service itself, the mobile servers, the community 107, the gateway 103, the communication network 105, third party providers of the shared mobile web service, or a combination thereof. For example, in a community 107 created for sharing family photographs, an access policy limits a service consumer to downloading no more than 50 megabytes of photographic files in any 24-hour period. Accordingly, the shared services module 109 monitors the download quota (e.g., data quota) for each service consumer and stops further downloads when the data quota is reached.

In step 629, the shared services module 109 periodically generates a status message including, for instance, a current network address (e.g., an Internet protocol address or other attachment point to the communication network 105) and/or the current availability of the mobile server to provide the shared service. The status message may also include a context or load-balancing metric associated with the apparatus for providing the shared service (e.g., location, time, type of network connection, quality of service, device capability, nature of shared service). For example, the shared services module 109 may generate a status message when a mobile server enters or leaves the communication network 105 and registers or deregisters with the DDNS service 111 as described with respect to FIG. 1. Additionally, the shared services module 109 may generate the status message periodically, or as the mobile server's availability or ability to provide the shared mobile web service changes (e.g., when the mobile server's batteries reach a certain level or when the mobile is in a location to provide optimal service as described with respect to the FIGS. 6A and 6B). It is contemplated that the generation of the status message may be triggered according to a schedule, when the status of the mobile server changes, at the user's request, at the request of another network element (e.g., other mobile servers, the gateway 103, service consumers, etc.), or other appropriate trigger. The shared services module 109 then initiates transmission of the status message to the gateway 103, the community 107, the open access community group 1001, or a combination thereof (step 631).

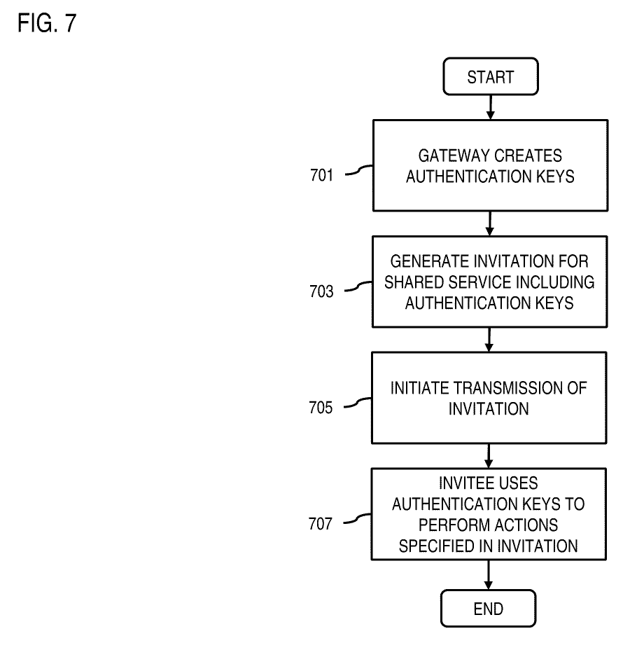

FIG. 7 is a flowchart of a process for authenticating users and providers of a shared mobile web service, according to an exemplary embodiment. In step 701, the gateway 103 creates authentication keys for using or providing a shared service. The authentication keys may include, for instance, shared secrets, seeds, or tokens for creating a unique universal resource locator (URL) address to give users access to the shared mobile web service or to authorize mobile servers to the provide the service. It is contemplated that providing the service includes hosting the same instance of the shared service or cloning a new instance of the service. As used herein, “cloning” includes creating another instance of the shared service to provide an identical service for another community 107.

In exemplary embodiments, the gateway 103 creates the authentication keys when the gateway 103 designates the community for providing the shared mobile web service as described with respect to FIG. 3. It is also contemplated that the gateway 103 may generate one or more of the authentication keys on request from a mobile server, a service consumer, or some other network element. Moreover, a separate authentication key may be created for each action (e.g., using, hosting, or cloning a shared service) or one authentication key may be used for all or any combination of the actions.

After creating the authentication keys, the shared services module 109 within a mobile server generates one or more invitations including one or more of the authentication keys for providing the shared service (step 703). By way of example, the shared services module 109 generates an invitation including an authentication key created for authorizing users to access the shared mobile web service. In exemplary embodiments, the invitation includes a unique URL based on the authentication key. Similarly, the shared services module 109 may generate another invitation including an authentication key created for authorizing a mobile server to host or clone a shared service (e.g., to act as a secondary server for the shared web service). The shared services module then initiates transmission of the invitation to either potential service consumers or other mobile servers (step 705). A recipient of the invitation uses the invitation along with the included authentication keys to perform the actions (e.g., using, hosting, or cloning) specified in the invitation (step 707). For example, the invitee visits the URL provided in the invitation to gain access to the shared mobile web service to perform the specified action. An example of using authentication keys to access or provide the shared web service is described with respect to FIG. 13.

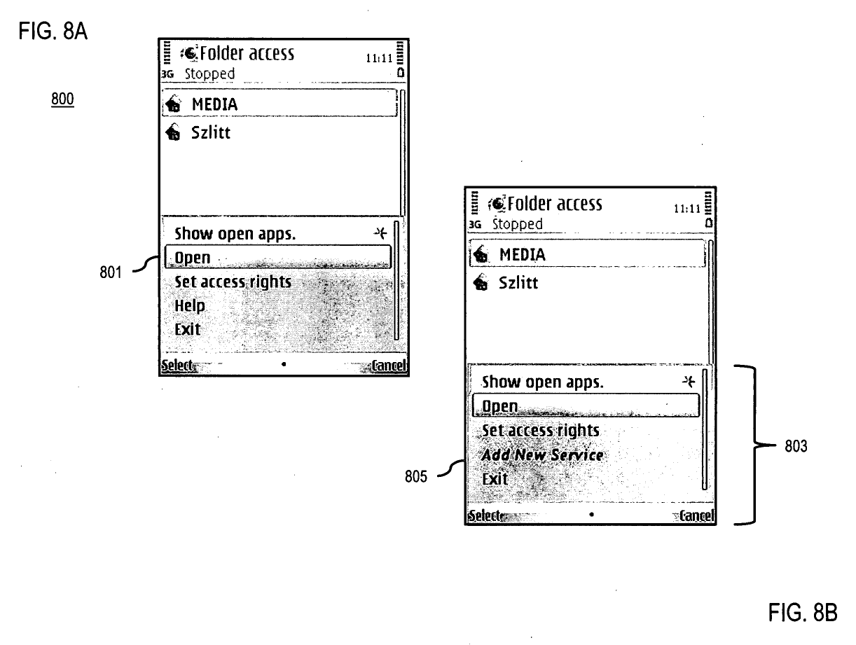

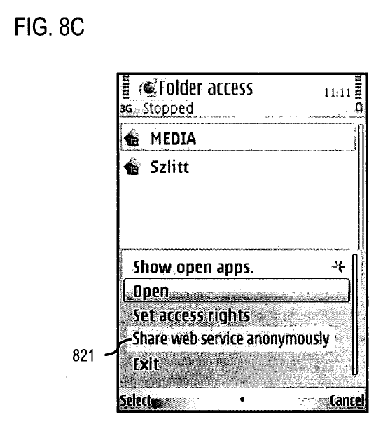

FIGS. 8A-8C are diagrams of a user interface utilized in the processes of FIGS. 5, 6A, and 6B according to an exemplary embodiment. In exemplary embodiments, the mobile web server (e.g., UE 101) is, for instance, a mobile handset with a limited display area. FIG. 8A depicts an initial menu screen 800 listing available menu options. By way of example, a user selects the “Open” menu option 801 to access a submenu 803 of FIG. 8B which contains an option to add a new web service. On selection of the add web service option 805, the user can be presented with, for instance, a list of available web services that can be installed on the UE 101. In addition, the user can be presented with an option 821 of FIG. 8C to share the web service anonymously as described with respect to FIGS. 6A, 6B, 10, and 11.

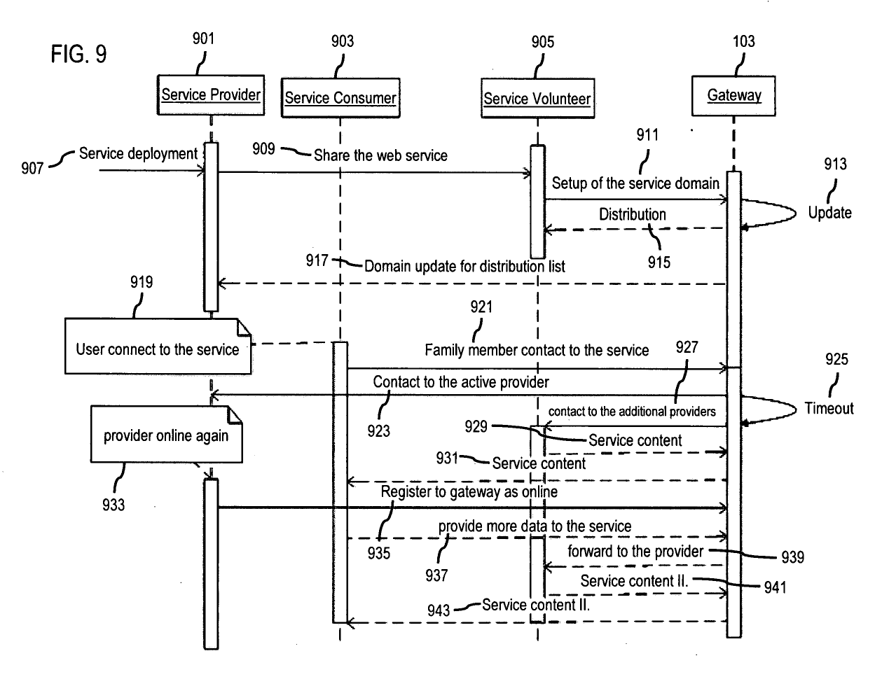

FIG. 9 is a ladder diagram that illustrates a sequence of messages and processes for providing a shared web service, according to an exemplary embodiment. A network process is represented by a thin vertical box. A message passed from one process to another is represented by horizontal arrows. A step performed by a process is indicated by a box or looping arrow overlapping the process at a time sequence indicated by the vertical position of the box or looping arrow.

The processes represented in FIG. 9 are a service provider 901, a service consumer 903, a service volunteer 905, and a gateway 103. The service provider 901 is an example of a primary mobile web server running a shared web service. The service consumer 903 is an example of a user of the shared web service. The service volunteer 905 is an example of a secondary mobile web server running a shared web service.

In response to a service deployment request 907, the service provider 901 installs and runs a web service. In exemplary embodiments, the service provider 901 may download the web service from an application server to install the web service. The installation process, for instance, includes initiating an action to share the web service 909 with the service volunteer 905. The service volunteer 905 then initiates setup of the service domain 911 (i.e., registration of the shared web service) with the gateway 103. The setup request 911 includes the service descriptor associated with the setup and identities the mobile servers providing the shared web service (e.g., service provider 901 and service volunteer 905).

On receipt of the request, the gateway 103 tracks the new shared web service. The update process 913 includes creating a new domain or subdomain name for the web service (if required) according to the distribution rule 207 associated with the web service. At this point, the gateway 103 designates a community 107 for sharing the web service. The gateway 103 also updates the distribution list 205 to designate the service provider 901 as the primary server for the web service and the service volunteer 905 as the secondary server. The gateway 103 then transmits the updated service descriptor and distribution list 205 to the service volunteer 905 in a message 915 and to the service provider 901 in a message 917.

After the web service is setup, a service consumer 903 initiates a command 919 to connect to the web service. In this example, the service consumer 903 is a family member of a community 107 of other family members sharing a web service. The command 919 initiates a request 921 to the gateway 103 for connection to the web service run by service provider 901. The gateway 103 determines the service provider associated with the requested web service (i.e., service provider 901) and forwards the service request to the service provider 901 in message 923. At this point, the service provider 901 is not online and is unable to service the request. The gateway 103 detects that the service request 923 to the service provider 901 has timed out 925 and selects a secondary server (i.e., service volunteer 905) that is running the shared web service. The gateway 103 sends a message 927 to service volunteer 905 forwarding the service request from service consumer 903. In response, the service volunteer 905 provides the requested service content 929 to the gateway 103 which then forwards the service content to the service consumer 903 in a message 931.

After this initial exchange between service consumer 903 and service volunteer 905, the service provider 901 comes back online 933 and registers with the gateway 103 via message 935. In the meantime, the exchange between service consumer 903 and service volunteer 905 continues with the service consumer 903 requesting additional data from the service via a message 937 to the gateway 103. Even though the primary service provider 901 is back online, the gateway 103 continues to forward the request from the ongoing session of the service consumer 903 to the service volunteer 905 via message 939 because the service volunteer 905 was the first provider relative to the request of the service consumer 903. The service volunteer 905 then sends the requested additional data to the gateway 103 via message 941. The gateway 103 completes the session by forwarding the data to the service consumer 903 via message 943.

FIG. 10 is a ladder diagram that illustrates a sequence of messages and processes for providing a shared web service anonymously, according to an exemplary embodiment. A network process is represented by a thin vertical box. A message passed from one process to another is represented by horizontal arrows. A step performed by a process is indicated by a box or looping arrow overlapping the process at a time sequence indicated by the vertical position of the box or looping arrow.

Identical processes with respect to FIG. 9 are represented using the same numbering scheme. The processes represented in FIG. 10 are a service provider 901, a service consumer 903, a service volunteer 905, a gateway 103, and an open access community group 1001. The open access community 1001 is an example of a social networking community or a subset of a social networking community that forms the community 107 for providing the shared service. For example, the social networking community may be created by an external provider (e.g., Facebook®, MySpace®) with connectivity to the gateway 103 via an application programming interface (API).

As shown in FIG. 10, the service provider 901 transmits a request 1003 to initiate an anonymous shared mobile web service to the gateway 103. By way of example, an anonymous web service does not provide the service consumer 903 with the identities of the either the service provider 901 or any service volunteers 905. Instead, the service consumer accesses the anonymous shared service using a domain name assigned to the community 107 as a whole (e.g., service.mobile.net). In this example, the request 1003 includes specification of an external social networking community (e.g., the open access community group 1001) to act as the community 107 for providing the anonymous mobile web service.

On receipt of the request 1003, the gateway 103 sends a request 1005 to the open access community group 1001 to create or perform an update 1007 of the domain (e.g., service.mobile.net) associated with the shared service to include the specified members of the open access community group 1001. The open access community group 1001 confirms the creation or update of the domain to the gateway 103 in a message 1009. Following confirmation, the gateway 103 updates the distribution list 205 associated with the anonymous shared service and transmits the update 1011 to the service provider 901 to complete the initial setup of the community 107 for sharing the anonymous mobile web service.

At this point, a service volunteer 905 sends a request 1013 to the open access community group 1001 to join the community for providing the shared service anonymously. The open access community group 1001 performs an update 1015 to add the new service volunteer 905 and confirms the action to the gateway 103 in a message 1017. The gateway 103 then initiates a distribution 1019 of the shared web service to the service volunteer 905 for installation. After installation the service volunteer 905 is ready to begin providing the service anonymously.

In the next sequence, a service consumer initiates a command 1021 to connect to the web service. The command 1021 initiates a request 1023 to the gateway 103 for connection to the web service provided by the open access community group 1001. The request 1023, for instance, identifies only the domain associated with the community group 1001. The gateway 103 then forwards the request in a message 1025 to the service provider 901 that is, for example, the last known active provider of the shared service.

At this point, however, the service provider 901 is not online and is unable to service the request. The gateway 103 detects that the message 1025 to the service provider 901 has timed out 1027 and transmits a query 1029 to the open access community group 1001 for available mobile servers. The open access community group 1031 returns a distribution list 1031 of available mobile servers. This list 1031, for instance, is created or updated when in response to a request, each mobile server in the community reports its presence (e.g., availability to provide the shared service) to the open access community group 1001. That is, each member of the community is able to respond, resulting in the creation of a distribution list. In this example, the list 1031 includes the service volunteer 905 that has joined to provide the service anonymously. Using the list 1031, the gateway 103 sends a message 1033 to the anonymous service volunteer 905 forwarding the service request from service consumer 903. In response, the anonymous service volunteer 905 provides the requested content 1035 to the gateway 103. The gateway 103 then forwards the service content to the service consumer 903 in a message 1037 without identifying the anonymous service volunteer 905.

After this initial exchange between service consumer 903 and anonymous service volunteer 905, the service provider 901 comes back online 1039 and registers with the gateway 103 via message 1041. In the meantime, the exchange between the service consumer 903 and the anonymous service volunteer 905 continues with the service consumer 903 requesting additional data from the service via a message 1043 to the gateway 103. Even though the primary service provider 901 is back online, the gateway 103 continues to forward the request from the ongoing session of the service consumer 903 to the anonymous service volunteer 905 via message 1045 because the anonymous service volunteer 905 was the first provider relative to the request of the service consumer 903. The anonymous service volunteer 905 then sends the requested additional data to the gateway 103 via message 1047. The gateway 103 completes the session by forwarding the data to the service consumer 903 via message 1049.

FIG. 11 is a diagram depicting a service provider providing a shared service anonymously, according to an exemplary embodiment. As shown in FIG. 11, a service consumer 1101 requests information from a shared mobile web service (e.g., weather service 1103) that has been configured to provide the service anonymously without identifying the specific mobile server (e.g., primary server 1105 and secondary server 1107). In this case, the weather service 1103 has been registered with the gateway 103 under the domain “weather.mobile.net.” The weather service 1103 is provided by the weather service community 1107 including the service provider 1105 and the service volunteer 1107. The primary server 1105 is associated with the domain name “abc1.weather.mobile.net” and secondary server 1107 is associated with the domain name “xyz2.weather.mobile.net.” However, the domain names associated with the primary server 1105 and the secondary server 1107 are not provided to the service consumer 1101 in responding to the request for service.

Instead, the service consumer directs its request to the domain corresponding to the shared mobile web service as registered with the gateway 103 (i.e., weather.mobile.net). The gateway 103 and/or the weather service 1103 itself then routes the request to either the primary server 1105 or secondary server 1107 and provides the requested service as coming from the service domain (weather.mobile.net) rather than the individual domain names of the mobile servers.

FIG. 12 is a ladder diagram that illustrates a sequence of messages and processes for providing a shared web service as a passive server, according to an exemplary embodiment. As discussed with respect to FIGS. 6A and 6B, a mobile server may be an active server for providing a shared mobile web service to any service consumer (e.g., described above with respect to FIGS. 6A-6B, 9, and 10) or a passive server for providing a shared service to itself when other active servers are not available. FIG. 12 describes the latter option of a mobile server acting as a passive server.

As shown in FIG. 12, a network process is represented by a thin vertical box. A message passed from one process to another is represented by horizontal arrows. A step performed by a process is indicated by a box or looping arrow overlapping the process at a time sequence indicated by the vertical position of the box or looping arrow. Identical processes with respect to FIG. 9 are represented using the same numbering scheme. The processes represented in FIG. 10 are a service provider 901, a gateway 103, and a combined service consumer/service volunteer 1201. The combined service consumer/service volunteer 1201 is an example of a passive server.

The service provider 901 requests a web service by sending a message 1203 to the gateway 103 in the process described with respect to FIG. 10. The gateway 103 initiates the request service via an update 1205 and transmits the domain information including distribution list 205 for the web service in a message 1207 to the service provider 901. The combined service consumer/service volunteer 1201 joins the web as a passive server (e.g., passive service volunteer) via a message 1209 to the gateway 103. The gateway 103 registers the combined service consumer/service volunteer 1201 as a passive server in a process 1211. As a passive server, the combined service consumer/service volunteer 1201 does not actively serve any other service consumers. In another example embodiment, the combined service consumer/service volunteer 1201 is an active server and may actively server other service consumers.

At a later point in time, the combined service consumer/service volunteer 1201 initiates a command 1213 to connect to the web service. The command 1213 initiates a request 1215 to the gateway 103 for connection to the web service. The gateway 103 then forwards the request in a message 1217 to the service provider 901 that is, for example, the last known active provider of the shared service. At this point, however, the service provider 901 is not online and is unable to service the request. The gateway 103 detects that the message 1217 to the service provider 901 has timed out 1219 and searches for additional providers in a process 1221. There are, however, no active servers available to serve the request from the combined service consumer/service volunteer 1201. For example, all active servers may be offline and therefore not available. Alternatively, the combined service consumer/service volunteer may the first server in a community to install the service, and therefore there cannot be other active servers available.

Accordingly, the gateway 103 directs the combined service consumer/service volunteer 1201 in a message 1223 to serve local requests as a passive server. The message 1223, for example, includes a distribution of the web service to enable the combined service consumer/service volunteer 1201 to install a local copy of the web service. The combined service consumer/service volunteer 1201 then configures a local copy of the web service in a process 1225 and registers as a passive server with the gateway 103 via message 1227. The combined service consumer/service volunteer 1201 then serves local requests for the shared service from local users of UE 101 associated with 1201 (e.g. owner of the UE 101, or users allowed to access the service over a local wired or wireless link to the UE 101), in a process 1229. At this point, the service provider 901 comes back online 1231 and registers with the gateway 103 via a message 1233. Even though the primary server is back online, the combined service consumer/service volunteer 1201 continues to serve the local requests 1235 by default. However, it is contemplated that the combined service consumer/service volunteer 1201 may at any point elect to use the designated service provider 901 or other service volunteer 905 when the provider 901 or volunteer 905 is available, as well as elect to act as an active or passive server itself. In some embodiments, synchronizing any changes to service content taken place during the serving of local requests may be initiated as described with respect to FIGS. 6A and 6B.

FIG. 13 is a ladder diagram that illustrates a sequence of messages and processes for providing a shared web service using authentication keys, according to an exemplary embodiment. A network process is represented by a thin vertical line. A message passed from one process to another is represented by horizontal arrows. A step performed by a process is indicated by a box or a looping arrow overlapping the process at a time sequence indicated by the vertical position of the box or looping arrow. Identical processes with respect to FIG. 9 are represented using the same numbering scheme. The processes represented in FIG. 13 are a service provider 901, a service consumer 903, a service volunteer 905, and a gateway 103.

In this example, it is assumed that the shared mobile web service has been setup according to the steps described with respect to FIG. 10 in a process 1301. At the end of the process 1301, the gateway 103 generates one or more authentication keys for using, hosting, or cloning the shared service. As discussed with respect to FIG. 7, the authentication key may include shared secrets or seeds for creating a URL for accessing the shared service. The service provider 901 then installs the shared service and the authentication keys in a process 1305 to begin acting as a mobile server for the service. After installation, the service provider 901 registers as being online to the gateway 103 via a message 1303.

To invite service consumers to use the share service, the service provider 901 generates an invitation including one or more authentication keys and associated URL(s) in a process 1307 and transmits the invitation to the service consumer 903 via a message 1309. The service consumer 903 opens the invitation 1311 and visits the authentication key-based URL to request authentication to access the shared service via a message 1313 to the gateway 103. The gateway 103 verifies the authentication key used by the service consumer 903 in a process 1315 (e.g., by verifying that the URL is based on the authentication key) to allow the service consumer 903 access to use the service provided by the service provider 901 via a message 1317. It is contemplated that the same authentication process may be used to invite the service volunteer 905 to either host or clone the shared service.

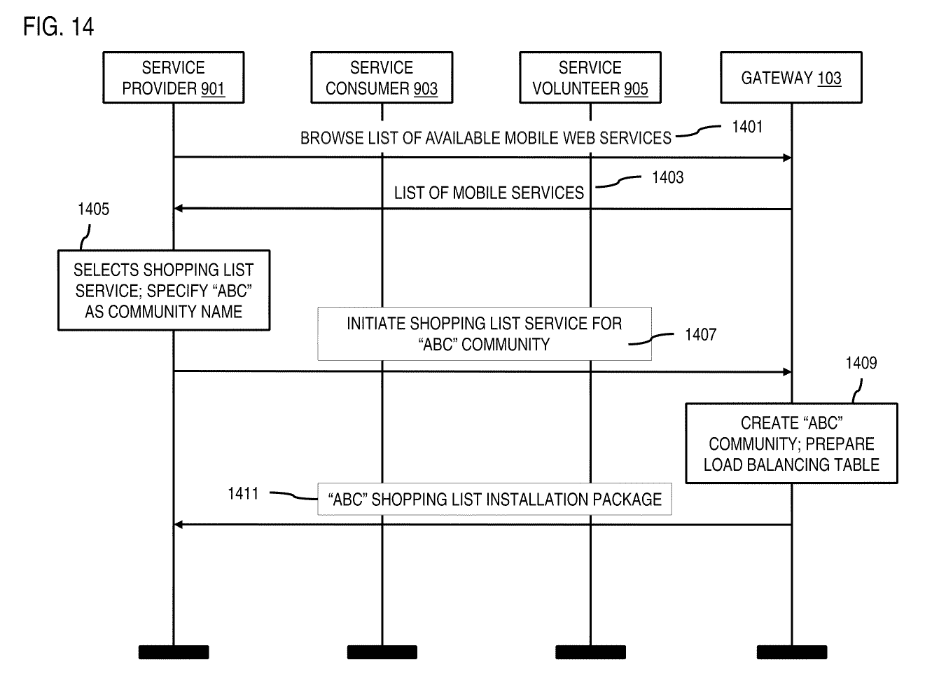

FIG. 14 is a ladder diagram that illustrates a sequence of messages and processes for load-balancing a shared web service, according to an exemplary embodiment. In exemplary embodiments, the gateway 103 may use load-balancing to ensure that the resource loads on mobile servers providing a shared mobile web service with the community 107 are evenly distributed. FIG. 14 illustrates the load-balancing approach with respect to an exemplary service for sharing shopping lists.

A network process is represented by a thin vertical line. A message passed from one process to another is represented by horizontal arrows. A step performed by a process is indicated by a box or a looping arrow overlapping the process at a time sequence indicated by the vertical position of the box or looping arrow. Identical processes with respect to FIG. 9 are represented using the same numbering scheme. The processes represented in FIG. 13 are a service provider 901, a service consumer 903, a service volunteer 905, and a gateway 103.

In this example, the service provider transmits a message 1401 to the gateway 103 containing a request to browse a list of available mobile web services. The gateway 103 transmits the list 1403 to the service provider 901 per the request. The service provider 901 browses the list and, for instance, selects to initiate a shopping list shared web service with “ABC” as the community name in a process 1405. The service provider 901 transmits a request 1407 to the gateway 103 to initiate the service. On receipt of the request, the gateway 103 creates the “ABC” community with, for instance, a domain name of “abc.shoppinglist.mobile.net” in a process 1409. At the same time, the gateway 103 also prepares a load-balancing table. By way of example, the load-balancing table identifies the each mobile server within the community along with load-balancing metrics (e.g., location, time, type of network connection, quality of service, device capability, nature of the shared service) and applicable access policies associated with each mobile server. The access policies include a bandwidth threshold, data quota, limit on the number of connections, threshold on transfer ratio, or a combination thereof as discussed with respect to FIG. 6B. As each mobile server comes online and periodically thereafter, each mobile server reports its status including its status with respect to the load-balancing metrics. The gateway 103 uses the status reports to update the load-balancing table. The gateway may then distribute requests from service consumers to the mobile servers within the community 107 based on the load-balancing table.

The described processes and arrangement advantageously, according to certain embodiments, provide for sharing of mobile web services.

The processes described herein for providing shared mobile web services may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

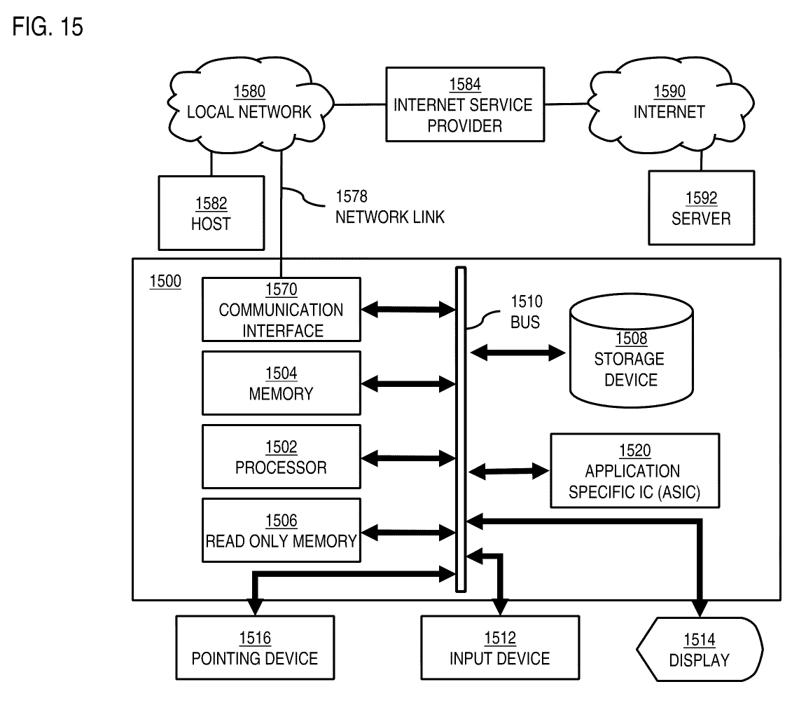

FIG. 15 illustrates a computer system 1500 upon which an embodiment of the invention may be implemented. Computer system 1500 is programmed to carry out the inventive functions described herein and includes a communication mechanism such as a bus 1510 for passing information between other internal and external components of the computer system 1500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1510 includes one or more parallel conductors of information so that information is transferred quickly among devices coupled to the bus 1510. One or more processors 1502 for processing information are coupled with the bus 1510.

A processor 1502 performs a set of operations on information. The set of operations include bringing information in from the bus 1510 and placing information on the bus 1510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1500 also includes a memory 1504 coupled to bus 1510. The memory 1504, such as a random access memory (RAM) or other dynamic storage device, stores information including processor instructions. Dynamic memory allows information stored therein to be changed by the computer system 1500. RAM allows a unit of information stored at a location called a memory address to be stored and retrieved independently of information at neighboring addresses. The memory 1504 is also used by the processor 1502 to store temporary values during execution of processor instructions. The computer system 1500 also includes a read only memory (ROM) 1506 or other static storage device coupled to the bus 1510 for storing static information, including instructions, that is not changed by the computer system 1500. Some memory is composed of volatile storage that loses the information stored thereon when power is lost. Also coupled to bus 1510 is a non-volatile (persistent) storage device 1508, such as a magnetic disk, optical disk or flash card, for storing information, including instructions, that persists even when the computer system 1500 is turned off or otherwise loses power.

Information, including instructions, is provided to the bus 1510 for use by the processor from an external input device 1512, such as a keyboard containing alphanumeric keys operated by a human user, or a sensor. A sensor detects conditions in its vicinity and transforms those detections into physical expression compatible with the measurable phenomenon used to represent information in computer system 1500. Other external devices coupled to bus 1510, used primarily for interacting with humans, include a display device 1514, such as a cathode ray tube (CRT) or a liquid crystal display (LCD), or plasma screen or printer for presenting text or images, and a pointing device 1516, such as a mouse or a trackball or cursor direction keys, or motion sensor, for controlling a position of a small cursor image presented on the display 1514 and issuing commands associated with graphical elements presented on the display 1514. In some embodiments, for example, in embodiments in which the computer system 1500 performs all functions automatically without human input, one or more of external input device 1512, display device 1514 and pointing device 1516 is omitted.

In the illustrated embodiment, special purpose hardware, such as an application specific integrated circuit (ASIC) 1520, is coupled to bus 1510. The special purpose hardware is configured to perform operations not performed by processor 1502 quickly enough for special purposes. Examples of application specific ICs include graphics accelerator cards for generating images for display 1514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1500 also includes one or more instances of a communications interface 1570 coupled to bus 1510. Communication interface 1570 provides a one-way or two-way communication coupling to a variety of external devices that operate with their own processors, such as printers, scanners and external disks. In general the coupling is with a network link 1578 that is connected to a local network 1580 to which a variety of external devices with their own processors are connected. For example, communication interface 1570 may be a parallel port or a serial port or a universal serial bus (USB) port on a personal computer. In some embodiments, communications interface 1570 is an integrated services digital network (ISDN) card or a digital subscriber line (DSL) card or a telephone modem that provides an information communication connection to a corresponding type of telephone line. In some embodiments, a communication interface 1570 is a cable modem that converts signals on bus 1510 into signals for a communication connection over a coaxial cable or into optical signals for a communication connection over a fiber optic cable. As another example, communications interface 1570 may be a local area network (LAN) card to provide a data communication connection to a compatible LAN, such as Ethernet. Wireless links may also be implemented. For wireless links, the communications interface 1570 sends or receives or both sends and receives electrical, acoustic or electromagnetic signals, including infrared and optical signals, that carry information streams, such as digital data. For example, in wireless handheld devices, such as mobile telephones like cell phones, the communications interface 1570 includes a radio band electromagnetic transmitter and receiver called a radio transceiver.

The term computer-readable medium is used herein to refer to any medium that participates in providing information to processor 1502, including instructions for execution. Such a medium may take many forms, including, but not limited to, non-volatile media, volatile media and transmission media. Non-volatile media include, for example, optical or magnetic disks, such as storage device 1508. Volatile media include, for example, dynamic memory 1504. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 16 illustrates a chip set 1600 upon which an embodiment of the invention may be implemented. Chip set 1600 is programmed to carry out the inventive functions described herein and includes, for instance, the processor and memory components described with respect to FIG. 15 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 1600 includes a communication mechanism such as a bus 1601 for passing information among the components of the chip set 1600. A processor 1603 has connectivity to the bus 1601 to execute instructions and process information stored in, for example, a memory 1605. The processor 1603 may include one or more processing cores with each core configured to perform independently. A multi-core processor enables multiprocessing within a single physical package. Examples of a multi-core processor include two, four, eight, or greater numbers of processing cores. Alternatively or in addition, the processor 1603 may include one or more microprocessors configured in tandem via the bus 1601 to enable independent execution of instructions, pipelining, and multithreading. The processor 1603 may also be accompanied with one or more specialized components to perform certain processing functions and tasks such as one or more digital signal processors (DSP) 1607, or one or more application-specific integrated circuits (ASIC) 1609. A DSP 1607 typically is configured to process real-word signals (e.g., sound) in real time independently of the processor 1603. Similarly, an ASIC 1609 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1603 and accompanying components have connectivity to the memory 1605 via the bus 1601. The memory 1605 includes both dynamic memory (e.g., RAM, magnetic disk, writable optical disk, etc.) and static memory (e.g., ROM, CD-ROM, etc.) for storing executable instructions that when executed perform the inventive steps described herein. The memory 1605 also stores the data associated with or generated by the execution of the inventive steps.

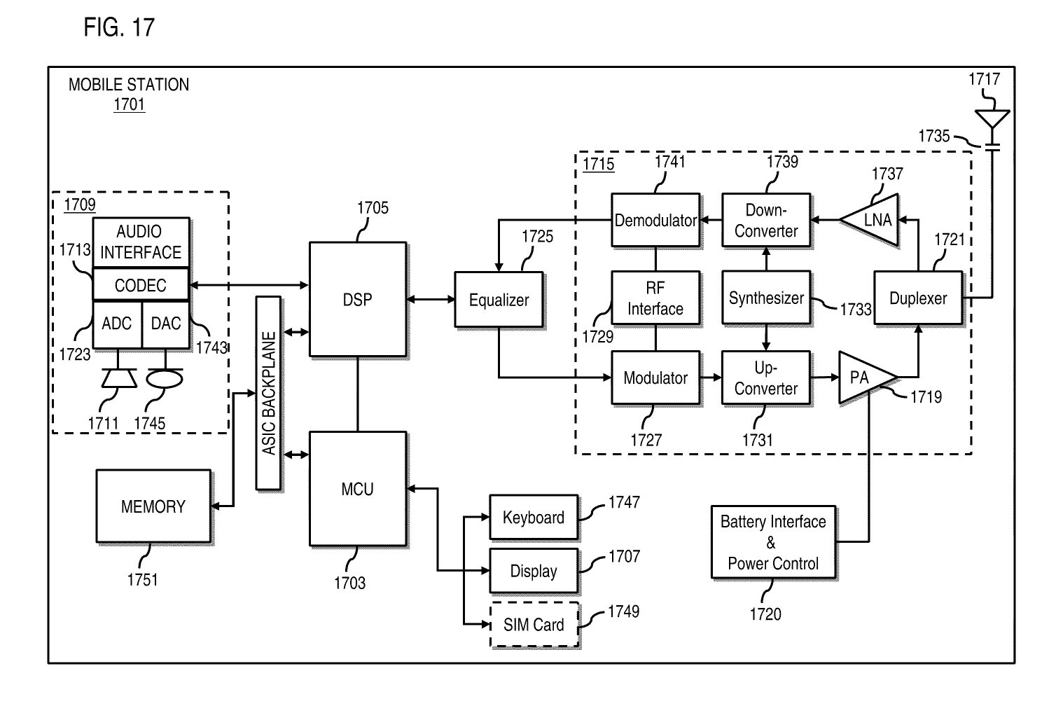

FIG. 17 is a diagram of exemplary components of a mobile station (e.g., handset) capable of operating in the system of FIG. 1, according to an exemplary embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1703, a Digital Signal Processor (DSP) 1705, and a receiver/transmitter unit including a microphone gain control unit and a speaker gain control unit. A main display unit 1707 provides a display to the user in support of various applications and mobile station functions. An audio function circuitry 1709 includes a microphone 1711 and microphone amplifier that amplifies the speech signal output from the microphone 1711. The amplified speech signal output from the microphone 1711 is fed to a coder/decoder (CODEC) 1713.

A radio section 1715 amplifies power and converts frequency in order to communicate with a base station, which is included in a mobile communication system, via antenna 1717. The power amplifier (PA) 1719 and the transmitter/modulation circuitry are operationally responsive to the MCU 1703, with an output from the PA 1719 coupled to the duplexer 1721 or circulator or antenna switch, as known in the art. The PA 1719 also couples to a battery interface and power control unit 1720.

In use, a user of mobile station 1701 speaks into the microphone 1711 and his or her voice along with any detected background noise is converted into an analog voltage. The analog voltage is then converted into a digital signal through the Analog to Digital Converter (ADC) 1723. The control unit 1703 routes the digital signal into the DSP 1705 for processing therein, such as speech encoding, channel encoding, encrypting, and interleaving. In the exemplary embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1725 for compensation of any frequency-dependent impairments that occur during transmission though the air such as phase and amplitude distortion. After equalizing the bit stream, the modulator 1727 combines the signal with a RF signal generated in the RF interface 1729. The modulator 1727 generates a sine wave by way of frequency or phase modulation. In order to prepare the signal for transmission, an up-converter 1731 combines the sine wave output from the modulator 1727 with another sine wave generated by a synthesizer 1733 to achieve the desired frequency of transmission. The signal is then sent through a PA 1719 to increase the signal to an appropriate power level. In practical systems, the PA 1719 acts as a variable gain amplifier whose gain is controlled by the DSP 1705 from information received from a network base station. The signal is then filtered within the duplexer 1721 and optionally sent to an antenna coupler 1735 to match impedances to provide maximum power transfer. Finally, the signal is transmitted via antenna 1717 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1701 are received via antenna 1717 and immediately amplified by a low noise amplifier (LNA) 1737. A down-converter 1739 lowers the carrier frequency while the demodulator 1741 strips away the RF leaving only a digital bit stream. The signal then goes through the equalizer 1725 and is processed by the DSP 1705. A Digital to Analog Converter (DAC) 1743 converts the signal and the resulting output is transmitted to the user through the speaker 1745, all under control of a Main Control Unit (MCU) 1703—which can be implemented as a Central Processing Unit (CPU) (not shown).

The MCU 1703 receives various signals including input signals from the keyboard 1747. The keyboard 1747 and/or the MCU 1703 in combination with other user input components (e.g., the microphone 1711) comprise a user interface circuitry for manager user input. The MCU 1703 runs a user interface software to facilitate user control of at least some functions of the mobile station 1701. The MCU 1703 also delivers a display command and a switch command to the display 1707 and to the speech output switching controller, respectively. Further, the MCU 1703 exchanges information with the DSP 1705 and can access an optionally incorporated SIM card 1749 and a memory 1751. In addition, the MCU 1703 executes various control functions required of the station. The DSP 1705 may, depending upon the implementation, perform any of a variety of conventional digital processing functions on the voice signals. Additionally, DSP 1705 determines the background noise level of the local environment from the signals detected by microphone 1711 and sets the gain of microphone 1711 to a level selected to compensate for the natural tendency of the user of the mobile station 1701.

The CODEC 1713 includes the ADC 1723 and DAC 1743. The memory 1751 stores various data including call incoming tone data and is capable of storing other data including music data received via, e.g., the global Internet. The software module could reside in RAM memory, flash memory, registers, or any other form of writable storage medium known in the art. The memory device 1751 may be, but not limited to, a single memory, CD, DVD, ROM, RAM, EEPROM, optical storage, or any other non-volatile storage medium capable of storing digital data.

An optionally incorporated SIM card 1749 carries, for instance, important information, such as the cellular phone number, the carrier supplying service, subscription details, and security information. The SIM card 1749 serves primarily to identify the mobile station 1701 on a radio network. The card 1749 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. An apparatus comprising a processor and a memory storing executable instructions that if executed cause the apparatus to at least perform the following:
joining a community of a plurality of mobile servers for sharing a service; and
providing the service to a service consumer.

2. An apparatus of claim 1, wherein the apparatus is caused to further perform:
initiating synchronization of the shared service within the community,
wherein the community is a social networking community or a subset of the social networking community.

3. An apparatus of claim 1, wherein the apparatus is configured to provide the shared service anonymously.

4. An apparatus of claim 1, wherein the apparatus comprises a mobile server configured to provide the shared service in response to local requests.

5. An apparatus of claim 1, wherein the apparatus is caused to further perform:
generating an invitation that includes an authentication key for the service consumer to use the shared service, or for one or more of the mobile servers to host or clone the shared service; and
initiating the transmission of the invitation to either the service consumer or the one or more mobile servers.

6. An apparatus of claim 1, wherein the apparatus is caused to further perform:
receiving a designation to act as a service volunteer for the shared service; and
providing the shared service to the service consumer when one or more of the plurality of mobile servers are unavailable.

7. An apparatus of claim 6, wherein the designation of the service volunteer or the availability of a mobile server is specified by a predetermined or a user-specified setting, context or service criteria including location, time, type of network connection, quality of service, device capability, nature of the shared service, or a combination thereof.

8. An apparatus of claim 1, wherein the apparatus is caused to further and repeatedly perform:
generating a status message including a current network address and availability to act as a mobile server; and
initiating transmission of the status message to the gateway, the community, an open access community group, or a combination thereof.

9. An apparatus of claim 8, wherein the status message includes a context or load-balancing metric associated with the apparatus for providing the shared service including location, time, type of network connection, quality of service, device capability, nature of the shared service, or a combination thereof.

10. An apparatus of claim 1, wherein the apparatus is caused to further perform:
enforcing an access policy on the service consumer,
wherein the access policy includes a bandwidth threshold, data quota, limit on the number of connections, transfer ratio, or a combination thereof.

11. A computer-readable storage medium carrying one or more sequences of one or more instructions which, when executed by one or more processors, cause an apparatus to at least perform:
joining a community of a plurality of mobile servers for sharing a service; and
providing the service to a service consumer.

12. A computer-readable storage medium of claim 11, wherein the apparatus is caused to further perform:
initiating synchronization of the shared service within the community,
wherein the community is a social networking community or a subset of the social networking community.

13. A computer readable storage medium of claim 11, wherein the apparatus is caused to further perform:
generating an invitation that includes an authentication key for the service consumer to use the shared service, or for one or more of the mobile servers to host or clone the shared service; and
initiating the transmission of the invitation to either the service consumer or the one or more mobile servers.

14. A computer readable storage medium of claim 11, wherein the apparatus is caused to further perform:
receiving a designation to act as a service volunteer for the shared service; and
providing the shared service to the service consumer when one or more of the plurality of mobile servers are unavailable.

15. A computer readable storage medium of claim 11, wherein the apparatus is caused to further and repeatedly perform:
generating a status message including a current network address and availability to act as a mobile server;
initiating transmission of the status message to the gateway, the community, an open access community group, or a combination thereof; and
enforcing an access policy on the service consumer.

16. A method comprising:
joining a community of a plurality of mobile servers for sharing a service; and
providing the service to a service consumer.

17. A method of claim 16, further comprising:
initiating synchronization of the shared service within the community,
wherein the community is a social networking community or a subset of the social networking community.

18. A method of claim 16, further comprising:
generating an invitation that includes an authentication key for the service consumer to use the shared service, or for one or more of the mobile servers to host or clone the shared service; and
initiating the transmission of the invitation to either the service consumer or the one or more mobile servers.

19. A method of claim 16, further comprising:
receiving a designation to act as a service volunteer for the shared service; and
providing the shared service to the service consumer when one or more of the plurality of mobile servers are unavailable.

20. A method of claim 16, further comprising:
generating a status message including a current network address and availability to act as a mobile server;
initiating transmission of the status message to the gateway, the community, an open access community group, or a combination thereof; and
enforcing an access policy on the service consumer.
